(19) United States
(12) Patent Application Publication
(10) Pub. No.: US 2008/0012262 A1
(43) Pub. Date: Jan. 17, 2008

(54) Suspension tilting module for a wheeled vehicle and a wheeled vehicle equipped with said suspension tilting module

(76) Inventors: Stefano Carabelli, Cesana Torinese (IT); Andrea Tonoli, Avigliana (IT); Andrea Festini, Collegno (IT); Fabio Cavalli, Alessandria (IT)

Correspondence Address: PAUL A. FATTIBENE;FATTIBENE & FATTIBENE, 2480 POST ROAD, SOUTHPORT, CT, 06890, US

(21) Appl. No.: 11/820,126

(22) Filed: Jun. 18, 2007

(30) Foreign Application Priority Data
Jun. 23, 2006 (EP) 06012974.9

(51) Int. Cl. B60G 21/05

(52) U.S. Cl. 280/124.106

(57) ABSTRACT

A tilting suspension system is provided for two wheels (2, 3) of a vehicle (200) disposed on a common axle with the module comprising a rigid frame (17) adapted to be firmly fixed to the chassis of the vehicle so as to be tilted together with the whole vehicle and a tilting arm (14) pivotally linked to the rigid frame. The tilting of the rigid frame is obtained as a result of the counter torque arising when activating hydraulic actuating means (101, 102) pivotally interposed between the tilting arm (14) and the rigid frame (17), with the tilting arm being pivotally connected to shock absorbers (18). The tilting module further comprises suspension arms (10, 11, 12, 13) pivotally connected to the rigid frame, with the suspension arms supporting, in cooperation with supporting uprights, the two wheels thus allowing both tilting and steering of the two wheels. The hydraulic actuating means (101, 102) are actuated by a hydraulic pump (112) driven by an electric motor (108).

### FIELD OF THE PRESENT INVENTION

The present invention relates to the field of automotive applications. In particular, the present invention relates to a suspension tilting module for wheeled vehicles and a wheeled vehicle equipped with such a suspension tilting module. In more detail, the present invention relates to a suspension tilting module allowing at least two wheels of a vehicle disposed on a common axle to be tilted together with the whole body of the vehicle. Still in more detail, the present invention relates to a suspension tilting module allowing both tilting and vertical displacement of said two wheels. Furthermore, the present invention relates to a suspension tilting module allowing it to adequately absorb shocks to which one or both of the two wheels are subjected, for instance, when one or both of the two wheels crosses a bump. Still in more detail, the present invention relates to a suspension tilting module equipped with hydraulic actuating means adapted to provide the torque needed for the tilting function. Finally, the present invention relates to a tilting module equipped with hydraulic actuating means exerting a torque on a tilting arm pivotally connected to a rigid frame which is in turn adapted to be firmly fixed to the chassis of the vehicle.

### DESCRIPTION OF THE PRIOR ART

Over the past few years, interest has grown towards vehicles with innovative configurations due to the increasing number of vehicles and the related problems of traffic congestion and pollution. Such vehicles are usually of small weight and size to minimize parking problems and to reduce losses due to rolling resistance and aerodynamic drag. In particular, the size of these vehicles is normally designed for one or two people, thus allowing for personal mobility. Moreover, the small size and weight of these vehicles allows for a reduction in engine power and, accordingly, emissions without compromising performance.

In particular, over the past years, many efforts have been devoted by car manufacturers to the development of so-called tilting vehicles, namely vehicles wherein all or part of the vehicle is inclined inward during cornering so that gravity and centrifugal forces are kept oriented along the vertical body axis of the vehicle. In other words, tilting vehicles are characterized by the capacity to bank over to the side like a motorbike or motorcycle. Accordingly, rollover can be avoided even if the track of the tilting vehicle is narrow with respect to that of conventional vehicles.

Several tilting vehicles have been proposed in the past with three or more wheels. In some three wheeled vehicles, the tilting is provided just to the body and the central wheel while the axis with two wheels does not tilt. On the contrary, in other cases, the solution is preferred according to which all wheels tilt with the body, since this solution allows for improved performance of the vehicle.

However, in spite of all the advantages offered by tilting vehicles, the further development of these vehicles has revealed that several problems have still to be solved or overcome. The tilting vehicles known in the art may be classified in essentially two categories, namely vehicles with manual tilting and vehicles with automated or active tilting where the tilting function is carried out by adequate actuating means driven by a control system. In manual tilting vehicles, the tilting command to the suspension system is provided by the driver. On the contrary, in the case of automated tilting an the use of actuating means, the tilting function is exploited by tilting actuators following a command of the driver and/or under the control of a control system adapted to collect information or data relating to either the driving conditions and/or the behavior of the vehicle and to generate corresponding commands which are then sent to the actuators. In particular, active tilting vehicles usually comprise a tilting suspension module and/or system wherein moving suspension elements are connected to a tilting actuator so that the motion of the tilting actuator controls the amount of tilting imposed on the vehicle. Moreover, a control system sends commands to the tilting actuator, with the commands being generated as a function of information relating to either the driving condition and/or the behavior of the vehicle collected by the control system.

However, providing tilting actuating means and/or devices adapted to adequately carry out the tilting function has revealed to be a very difficult task. For this reason, several actuating means have been proposed in the prior art. For instance, electromechanical actuating means have been proposed essentially based on electric motors mechanically coupled to a tilting mechanism by means of mechanical transmission means such as, for instance, transmission belts, mechanically interposed between one or more electric motors and a reduction gear. In this case, the tilting torque can be easily controlled by controlling the electrical current supplied to the electric motor while the mechanical gearbox is used to amplify the motor output torque.

Although there are evident advantages offered by electromechanical actuating means, it has to be appreciated that the electromechanical actuating means are still affected by several drawbacks. For instance, when a large reduction ratio is required between the rotational displacement of the electric motor and the rotational displacement of the reduction gear, the overall dimensions and the volume of the reduction gear increase drastically, so that it becomes difficult to conveniently position the reduction gear inside the vehicle. Accordingly, it becomes difficult to obtain a convenient layout of the vehicle. Moreover, due to the mechanical link between the electric motor and the tilting mechanism, the electric motor and the reduction gearbox have to be positioned into proximity of the tilting mechanism resulting in the total allowable tilting angle being limited and/or reduced, so that the tilting function may in some cases will not be satisfactory. Furthermore, a further drawback affecting the tilting vehicles equipped with an electromechanical tilting system relates to the fact that the overall mass and weight of the vehicle drastically increases, resulting in the tilting function being slowed down so that the vehicle is not tilted as quickly as required with corresponding problems arising, for instance in the case of emergency situations. Moreover, friction arises in the mechanical reduction gearbox, resulting in the efficiency of the actuating means being reduced and electric motors with increased performance, with increased overall dimensions and weight, being required. Moreover, the mechanical transmission may generate noise and/or vibrations resulting in a decreased driving comfort for the driver. Finally, due to the overall dimensions and weight of the known electromechanical actuating means, it becomes impossible to provide emergency actuating means adapted to provide the needed actuating torque in the case of failure of the main actuating means so that the vehicle no longer behaves as a tilting vehicle. For instance, in the case were the supply of electrical current to the electric motors is interrupted. Finally, regular inspections and/or maintenance operations are needed for the purpose of checking the mechanical transmissions, thus resulting in increasing overall maintenance costs for the vehicle. Accordingly, in view of the problems and/or drawbacks identified above, it would be highly convenient to provide a suspension tilting module that overcome the drawbacks affecting the prior art tilting solutions.

### SUMMARY OF THE INVENTION

In particular, it is an object of the present invention to provide a suspension tilting module for a wheeled vehicle allowing it to overcome the problems affecting the prior art tilting modules and/or systems of the kind equipped with electromechanical actuating means.

A further object of the present invention is that of providing a suspension tilting module equipped with actuating means which do not require any mechanical link between the power source providing the tilting torque and the tilting mechanism.

Still another object of the present invention is that of providing a suspension tilting module equipped with actuating means comprising a power source adapted to provide the tilting torque wherein the power source may be positioned and/or disposed at some distance from the suspension module, thus allowing improvement in the overall layout of the vehicle implementing this suspension tilting module.

Still a further object of the present invention is that of providing a suspension tilting module equipped with actuating means with reduced overall dimensions and weight, in particular, with overall dimensions and weight which are less than those of electromechanical actuating means.

Another object of the present invention is that of providing a suspension tilting module equipped with actuating means generating a reduced friction, in particular a friction which is less than that arising in the case of electromechanical actuating means.

Still a further object of the present invention is that of providing a suspension tilting module equipped with actuating means allowing the suspension tilting module to be transformed into a manually actuated suspension tilting module.

Moreover, a further object of the present invention is that of providing a suspension tilting module equipped with a redundant actuating system, namely an actuating system comprising main actuating means and emergency actuating means, wherein the emergency actuating means may start working in the case of failure of the main actuating means.

A further object of the present invention is that of providing a suspension tilting module equipped with active actuating means of reduced dimension, complexity and weight and adapted to work not only to brake the tilting system but also to actively carry out the tilting function.

To this end, according to the present invention, this is obtained by providing a suspension tilting module equipped with hydraulic actuating means adapted to actively exploit the tilting function, that is, hydraulic actuating means adapted to provide the tilting torque needed for tilting the suspension system.

In particular, according to a first embodiment of the present invention, a suspension tilting module is provided, namely a suspension tilting module for a wheeled vehicle comprising at least two wheels disposed on a common axle, the module comprising a suspension system adapted to support the at least two wheels allowing tilting of the at least two wheels, wherein the suspension tilting module comprises a rigid frame adapted to be firmly fixed to the chassis of he vehicle and pivotally supporting a tilting arm. The module further comprises hydraulic actuating means pivotally interposed between the rigid frame and the tilting arm, so that activation of the hydraulic actuating means results in a force being exerted on the tilting arm and the rigid frame being tilted together with the at least two wheels.

According to a further embodiment of the present invention, a suspension tilting module is provided, namely a module wherein the tilting arm comprises at least a first arm portion and wherein the hydraulic actuating means comprise at least a first hydraulic actuator adapted to exert a force on the at least first arm portion.

Still according to another embodiment of the present invention, a suspension tilting module is provided, namely a suspension tilting module wherein the at least first hydraulic actuator comprises a hydraulic cylinder.

According to still another embodiment of the present invention, a suspension tilting module is further provided, namely a suspension tilting module wherein the tilting arm comprises a second arm portion and wherein the hydraulic actuating means comprise a second hydraulic actuator adapted to exert a force on the second arm portion.

According to still a further embodiment of the present invention, a suspension tilting module is provided, namely a module further comprising at least one hydraulic pump hydraulically connected to the hydraulic actuating means.

According to further embodiment of the present invention, a suspension tilting module is also provided, namely a suspension tilting module further comprising at least one electric motor adapted to drive the at least one hydraulic pump.

Still according to a further embodiment of the present invention, a suspension tilting module is also provided, namely a suspension tilting module wherein the tilting arm is pivotally connected to a first shock absorber and a second shock absorber through pivotable connections, respectively.

According to the present invention, there is also provided a driving tilting suspension system, namely a driving tilting suspension system comprising a suspension tilting module along with two wheels rotatably connected to said module.

According to a further embodiment of the present invention, a driving tilting suspension system is further provided, namely a driving tilting suspension system further comprising at least one electronic control unit adapted to collect data relating to the driving condition and/or the behavior of the vehicle and to emit electrical signals as a result of the collected data.

According to another embodiment of the present invention, a wheeled vehicle is provided, namely a vehicle comprising at least two wheels, the vehicle being equipped with a driving tilting suspension system according to the embodiments of the present invention.

Further embodiments, features or details of the present invention are more fully described and defined in the following more detailed description.

### BRIEF DESCRIPTION OF THE DRAWINGS

In the following, a description will be given with reference to the drawings of particular and/or preferred embodiments of the present invention. It has, however, to be noted that the present invention is not limited to the embodiments disclosed but that the embodiments disclosed only relate to particular examples of the present invention, the scope of which is defined by the appended claims. In particular, in the drawings:

FIG. 1 is a schematic perspective view of a first embodiment of the suspension tilting module and the tilting suspension system according to a first embodiment of the present invention;

FIG. 2 is a schematic front view of the embodiment of the present invention depicted in FIG. 1;

FIG. 3 is a schematic rear view of the embodiment of the present invention depicted in FIG. 1;

FIG. 4 relates to a schematic front view of the embodiment of the present invention depicted in FIG. 1 when tilted at a predefined angle;

FIG. 5 relates to a schematic front view of the embodiment of the present invention depicted in FIG. 1, showing the behavior of this embodiment when one of the wheels is subjected to a vertical displacement;

FIG. 6 relates to a schematic view of the overall electrical mechanical and hydraulic layout of one embodiment of the suspension tilting module and the tilting driving suspension system according to the present invention;

FIG. 7 relates to a schematic perspective view of a four wheeled vehicle equipped with two suspension tilting modules and tilting driving suspension systems according to the present invention; and

FIG. 8 relates to a schematic perspective view of a three wheeled vehicle implementing one suspension tilting module and one tilting driving suspension system according to the present invention.

### DETAILED DESCRIPTION OF THE PREFERRED EMBODIMENTS

While the present invention is described with reference to the embodiments as illustrated in the following detailed description as well as in the drawings, it should be understood that the following detailed description as well as the drawings are not intended to limit the present invention to the particular illustrative embodiments disclosed, but rather that the described illustrative embodiments merely exemplify the various aspects of the present invention, the scope of which is defined by the appended claims.

As apparent from the disclosure given above, the present invention is understood to be particularly advantageous when used for applications in the automotive field; in particular, the present invention is understood to be particularly advantageous when applied to the steering wheels of vehicles. For this reason, examples with be given in the following in which corresponding embodiments of the tilting module and/or system according to the present invention are described in combination with steering wheels. However, it has to be noted that the present invention is not limited to the particular case of a tilting module and system for steering wheels, but can be used in any other situation in which two wheels of a vehicle disposed on a common axle need to be tilted. Accordingly, it will become apparent from the following disclosure that the present invention may also be used for automotive applications in which, for instance, the steering wheels are not tilted. Moreover, even if those examples of wheeled vehicles disclosed in the present application and implementing the present invention mostly relates to cars driven by a main combustion engine, it has to be understood that the possible implementations of the tilting module and system according to the present invention are not limited to these kind of vehicles; on the contrary, the tilting module and system according to the present invention may also be conveniently implemented in different vehicles such as, for instance, tracks, trains, tractors or the like.

The present invention is based on the principle that adequate tilting can be conveniently obtained by active hydraulic actuating means adapted to generate the torque needed for tilting the vehicle. In particular, the present invention is based on the principle that hydraulic actuating means may be used instead of mechanical and/or electromechanical actuating means for the purpose of generating the required tilting torque. In more detail, the present invention is based on the principle that if the hydraulic actuating means are used in combination with an electric motor and an electric pump, with the electric motor driving the hydraulic pump and with the hydraulic pump driving the hydraulic actuating means, the hydraulic actuating means may be used to multiply the torque provided by the electric motor in order to obtain the required tilting torque. Accordingly, the proposed solution exploits the large reduction ratios that can be obtained by hydraulic systems. Moreover, the tilting force or torque may be controlled by the electric motor torque, without any need of any servo valve; accordingly, the system is adapted to work with a fixed volume of hydraulic fluid so that a fluid reservoir is needed only for the purpose of compensating for the unavoidable leakages. Furthermore, the system may be regarded as a by-wire system, since all the functions of the system may be controlled by an electronic control unit and a power electronic unit, in combination, with the electronic control unit being adapted to collect data relating to the driving conditions and/or the behavior of the vehicle and to provide the power electronic unit with corresponding signals allowing the power electronic units to drive the electric motor and, accordingly, the overall tilting actuating system. Moreover, if an isolation valve is used, this isolation valve may be used to isolate the hydraulic actuators from the rest of the actuating means, for instance from the hydraulic pump, so that the active tilting module can be transformed into a manually actuated tilting module. Moreover, isolating the hydraulic actuators from the hydraulic pump by means of the isolation valve also allows blocking the tilting module at a predefined position so as to avoid any tilting of the module which is, therefore, transformed in a fixed, non-tilting suspension module.

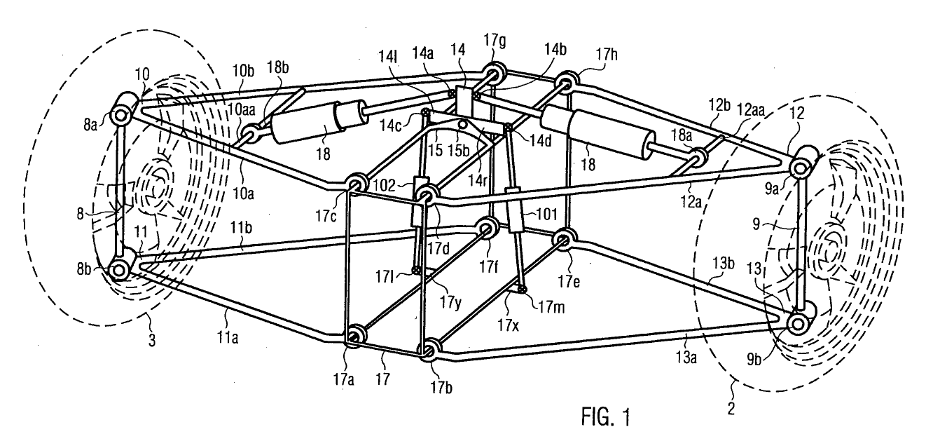

In the following with reference to FIG. 1, a first embodiment of the tilting module and system according to the present invention will be described.

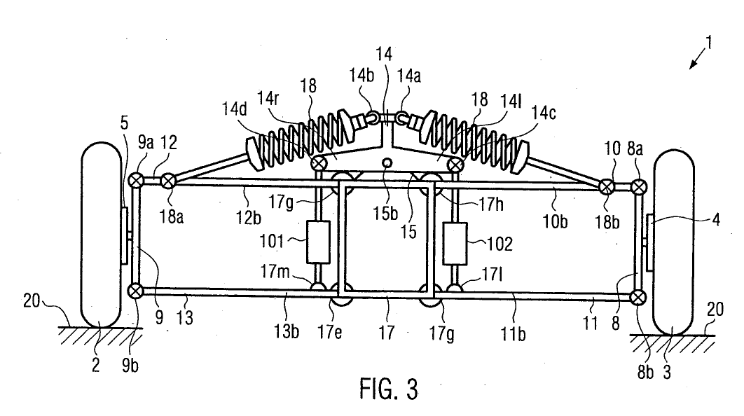

As apparent from FIGS. 1, 2 and 3, the tilting module and system depicted therein comprise a suspension structure or system defined by a rigid frame 17 and four suspension wishbone arms 10, 11, 12 and 13. In particular, the suspension structure comprises a first upper wishbone arm 12 defined by a front wishbone portion 12a and a rear wishbone portion 12b, illustrated in FIG. 3. In the same way, the suspension structure comprises a first lower wishbone arm 13 defined by a front wishbone portion 13a and a rear wishbone portion 13b. Similarly, the suspension structure comprises a second upper wishbone arm 10 defined by a front wishbone portion 10a and a rear wishbone portion 10b, illustrated in FIG. 3. Moreover, the suspension structure comprises a second lower wishbone arm 11 defined by a front wishbone portion 11a and a rear wishbone portion 11b. The front wishbone portions 12a and 13a of the first upper arm 12 and the first lower arm 13, respectively, are pivotally connected to the rigid frame 17 through pivotable connections 17d and 17b, respectively. In the same way, the front wishbone portions 10a and 11a of the second upper arm 10 and the second lower arm 11, respectively, are pivotally connected to the rigid frame 17 through pivotable connections 17c and 17a, respectively. The rear wishbone portions 13b and 11b of the first lower arm 13 and the second lower arm 11, respectively, are pivotally connected to the rigid frame 17 through pivotable connections 17e and 17f, respectively. The rigid frame 17 pivotally supports a tilting arm 14; in particular, as depicted in FIG. 1, the tilting arm 14 is pivotally connected to a bridge portion 15 of the rigid frame 17 through a pivotable connection 15b. Moreover, said tilting arm 14 has the shape of a inverted T with a first tilting arm portion 14l and a second tilting arm portion 14r. A third tilting arm portion extends from said first and second tilting arm portions 14l and 14r in a direction substantially perpendicular to said first and second tilting arm portions 14l and 14r. First and second hydraulic actuating means 102 and 101 are pivotally interposed between the tilting arm 14 and the rigid frame 17. In particular, as apparent from FIGS. 1, 2 and 3, first hydraulic actuating means 102 are pivotally interposed between the first tilting arm portion 14l and the rigid frame 17, with the first hydraulic actuating means 102 being pivotally connected to both the first tilting arm portion 14l and an extension portion 17y of the rigid frame 17 through pivotable connections 14c and 17l, respectively. In the same way, second hydraulic actuating means 101 are pivotally connected to both the second tilting arm portion 14r of the tilting arm 14 and to an extension portion 17x of the rigid frame 17 through pivotable connections 14d and 17m, respectively.

By way of example, said first and second hydraulic actuating means 102 and 101 may comprise first and second hydraulic cylinders, respectively, for instance single effect hydraulic cylinders, namely hydraulic cylinders adapted to exert a force only along a unique predefined direction. Alternatively, said first and second hydraulic cylinders 102 and 101 may comprise double effect hydraulic cylinders namely hydraulic cylinders adapted to exert a force along a first predefined direction and along a second predefined direction substantially contrary to the first predefined direction. When double effect hydraulic cylinders are selected, a unique hydraulic double effect cylinder may be used, for instance the first hydraulic cylinder 102 depicted in FIGS. 1, 2 and 3; in this case, the tilting arm 14 may have an L-shaped portion with a first tilting arm portion pivotally connected to the unique hydraulic double effect cylinder 102 through a pivotable connection 14c and a second portion extending substantially perpendicularly from the first tilting arm portion 14l.

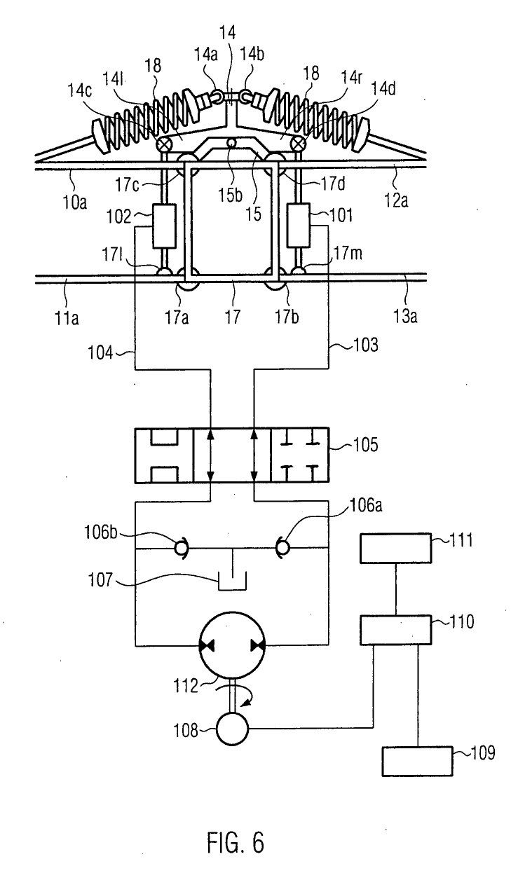

The hydraulic actuating means 102 and 101 may be actuated by means of a pump, for instance a fixed displacement hydraulic pump driven by one or more electric motors. While a detailed description of the electromechanical layout of the tilting module and system according to the present invention will be given in the following with reference to FIG. 6, it may be appreciated at this stage of the description that actuating one or both of the hydraulic actuating means 102 and 101 results in a torque being exerted on the tilting arm 14, with the rigid frame 17 being tilted with respect to the tilting arm 14, resulting therefore in the whole tilting module being tilted together with the two wheels 2 and 3 pivotally supported by said tilting module. Moreover, since in the most common implementations of the tilting module and system according to the present invention in a vehicle, the rigid frame 17 is firmly fixed to the chassis of the vehicle, therefore, tilting of the rigid frame 17 also results in the whole vehicle being tilted.

The suspension structure system of the tilting module of the present invention according to the embodiment depicted in FIGS. 1, 2 and 3 further comprises two shock absorbers 18 pivotally connected to both the tilting arm or crank 14 and to the upper wishbone arms 10 and 12. In particular, as depicted in FIG. 1, a first shock absorber 18 is pivotally connected to the actuating tilting arm or crank 14 through a pivotable connection 14a and to a bridged portion 10aa of the second upper arm 10 through a pivotable connection 18b, with said bridged portion 10aa being rigidly interposed between the front wishbone portion 10a and the rear wishbone portion 10b of the second upper wishbone arm 10. In the same way, a second shock absorber 18 is pivotally connected to both the tilting arm or crank 14 through a pivotable connection 14b and the bridged portion 12aa of the first upper arm 12 through a pivotable connection 18a, with said bridged portion 12aa being rigidly interposed between the front wishbone portion 12a and the rear wishbone portion 12b of the first upper wishbone arm 12. The reason why, in the embodiment depicted in FIGS. 1, 2 and 3, bridged portions 10aa and 12aa of the second upper wishbone arm 10 and the first upper wishbone arm 12, respectively, are used for the purpose of pivotally connecting the two shock absorbers 18 to the suspension system or structure relates to the fact that in the embodiment depicted in FIGS. 1, 2 and 3, the bridge portion 15 of the tilting frame 17, and accordingly the tilting arm 14 is provided in the central portion of the rigid frame 17 along a direction perpendicular to the bridged portion 15. However, other solutions are also possible, for instance solutions according to which the two shock absorbers 18 are pivotally connected to either the rear or front wishbone portions of the first and second upper wishbone arms 12 and 10. For instance, by placing the bridge portion 15 and, accordingly, the tilting arm 14 at the rear portion of the rigid frame in proximity of the pivotable connections 17g and 17h, the two shock absorbers 18 may be then pivotally connected directly to the rear wishbone portions 12b and 10b of the first and second wishbone arms 12 and 10, respectively. In the same way, by placing the wishbone portion 15 and, accordingly, the tilting arm 14 at the front portion of the rigid frame 17, for instance in proximity of the pivotable connections 17c and 17d, it would be possible to pivotally connect the two shock absorbers 18 directly to the front wishbone portions 12a and 10a of the first and second upper wishbone arms 12 and 10, respectively.

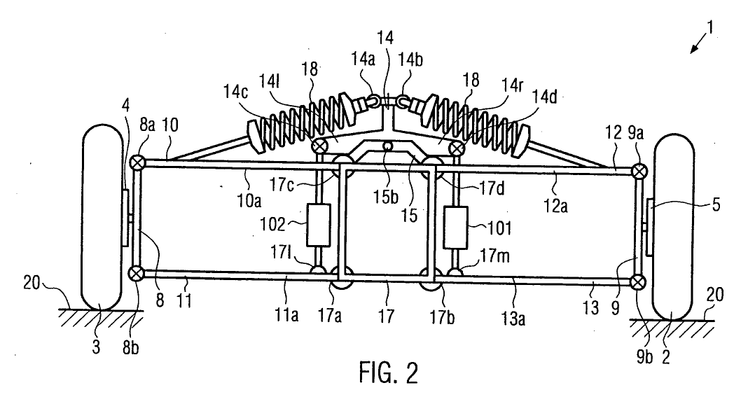

The suspension structure further comprises a first steering arm or upright 9 adapted to rotatably support a first wheel 2, as well as a second steering arm or upright 8 adapted to rotatably support a second wheel 3. The first upright 9 is supported by the first upper arm 12 and the first lower arm 13. In particular, the first upright 9 is pivotally connected to the first upper and lower arms 12 and 13 through pivotable connections 9a and 9b, respectively. In the same way, the second upright 8 is supported by the second upper arm 10 and the second lower arm 11; in particular, the second upright 8 is pivotally connected to the second upper arm 10 an the second lower arm 11 through pivotable connections 8a and 8b, respectively. The pivotable connections 9a, 9b, 8a and 8b allow both steering and tilting of the two wheels 2 and 3. Two motors 4 and 5 may be received in the hubs of the wheels 3 and 2, respectively as illustrated in FIGS. 2 and 3. Moreover, brake disks, not depicted in the drawings, may be provided on the wheels 2 and 3. Providing driving motors, for instance electric driving motors, in the hubs of the wheels 2 and 3 allows improving the driving performance of the vehicle. Moreover, at it will become apparent from the following disclosure, disposing driving motors in the hubs of the wheels does not limit the tilting angle. However, the tilting module and system according to the present invention are also adapted to be implemented in vehicles driven by a main engine, for instance a combustion engine disposed remotely from the tilting module and system.

In the following, a description will be given with reference to FIG. 6 of a possible electromechanical layout of a tilting system according to the present invention implementing the tilting module illustrated in FIG. 1. In FIG. 6, those features already described above with reference to previous figures are identified by the same reference numerals. Moreover, some features of the tilting module of FIGS. 1, 2 and 3 have been omitted in FIG. 6 for reasons of clarity.

As apparent from FIG. 6, the suspension tilting system depicted therein comprises the suspension tilting module, partially depicted, illustrated in FIGS. 1, 2 and 3. Moreover, in FIG. 6, reference numeral 112 identifies a hydraulic machine, for instance a reversible hydraulic pump, hydraulically connected to the hydraulic actuating means 102 and 101 through corresponding pipes 104 and 103, respectively. Moreover, an electric motor 108 is coupled to the hydraulic pump 112 so as to drive the hydraulic pump 112. A reservoir 107 is further provided for the purpose of containing a hydraulic fluid needed for the system, however, it has to be noted that the system can work with a fixed volume of fluid so that the reservoir 107 is needed just for compensating the unavoidable leakages. A pair of check valves 106b and 106a is hydraulically interposed between the hydraulic pipes 104 and 103 to ensure compensation of the leaks as well as of the asymmetries in the volume of liquid required by the hydraulic actuating means 102 and 101. Moreover, the two check valves 106b and 106a help to keep the intake port of the pump 112 at the pressure of the reservoir 107. Furthermore, an isolation valve 105 is also provided between the hydraulic pump 112 and the hydraulic actuating means 102 and 101, with said isolation valve allowing closing of the intakes of the hydraulic actuating means 102 and 101, thus connecting directly the two sides of the hydraulic pump 112, resulting in the electric motor 108 turning idle. Finally, as depicted in FIG. 6, the electric motor 108 is driven by one power electronic unit 110 working under the control of an electronic control unit 111. Moreover, a battery pack is provided, with said battery pack 109 being electrically connected to the power electronic unit 110 which is in turn electrically connected to both the electronic control unit 111 and the electric motor 108, as depicted in FIG. 6.

When the system operates under normal conditions, the electric motor 108 provides torque to the hydraulic pump 112 under the control of the power electronic power units 110 and the electronic control unit 111. For instance, to this end, the electronic control unit 111 may be conceived so as to be adapted to collect data relating to the behavior of the vehicle and/or the driving conditions. Such as, for instance, data relating to the speed of the vehicle or the lateral acceleration in case of turning or lateral wind or the like, and to supply corresponding signals to the power electronic unit 110 as a function of the data collected. In this way, the electric motor 108 may be adequately driven by the power electronic unit 110. For instance, the electric motor 108 may be driven so as to provide a predefined torque to the hydraulic pump 112, resulting in a predefined torque being exerted by the hydraulic actuating means 102 and 101 on the tilting arm 14. In the same way, the rotational speed of the electric motor 108 may be controlled, resulting in the hydraulic pump 112 being also driven at a predefined rotational speed so as to obtain a predefined actuation speed of one or both of the hydraulic means 102 and 101. The torque produced by the electric motor 108 drives the rotation of the hydraulic pump 112 that pumps fluid from one hydraulic actuating means 102 to the other hydraulic actuating means 101, thus resulting in a tilting torque being exerted on the tilting arm 14.

As it will become more apparent with the following description, applying a tilting torque to the tilting arm 14 results in the tilting frame 17 to be tilted with respect to the tilting arm 14, thus resulting in the whole suspension module and the two wheels being tilted.

When the need arises to lock the tilting movement of the tilting module, for example at low speed or during parking of the vehicle implementing the tilting system, it is possible to close the intakes of the two hydraulic actuating means 102 and 101 by activating the isolation valve 105 so as to close the two ports connected to the two hydraulic actuating means 102 and 101. The two ports connected to the hydraulic pump 112 may be connected together, as represented in FIG. 6. In this case, the right most part of the isolation valve 105 is used, so that the electric motor 108 is allowed to turn idle. It is also possible to short circuit all the hydraulic connections so that the tilting system is no longer actuated and can be controlled manually. In this case, the left most part of the isolation valve 105 is used.

It has to be noted that with the electromechanical layout depicted in FIG. 6, the hydraulic link between the hydraulic pump 112 and the hydraulic actuating means 102 and 101 is a direct link, i.e. no servo valves are needed. This solution allows the implementation of a fixed displacement hydraulic pump 112. Accordingly, the tilting force or torque applied to the tilting arm 14 can be controlled by the torque of the electric motor 108. Moreover, the system can work with a fixed volume of fluid, the fluid reservoir 107 being needed just for compensating the unavoidable leakages.

It has, furthermore, to be noted that several amendments and/or modifications of the electromechanical layout depicted in FIG. 6 are possible, without departing from the scope of the present invention. For instance, hydraulic motors may be used instead of the two hydraulic cylinders 102 and 101. Moreover, the solution implementing more than one electric motor is also possible to achieve redundancy. In particular, to realize a hot redundant system, the hydraulic pump 112 maybe driven by a pair of electric motors, each providing a percentage of the total power needed (e.g. 80%). This, in particular, allows the system to run in the case of failure of one of the two motors, since if a failure occurs with one electric motor, the second electric motor can provide torque to actuate the hydraulic pump 112. Moreover, solutions are also possible implementing more than one power electronic units and/or more than one electronic control unit and/or more than one battery. In particular, using two power electronic units, two electronic control units and two batteries allows a complete fully redundant system, i.e. a system with redundancy of both the power supplies and the controls.

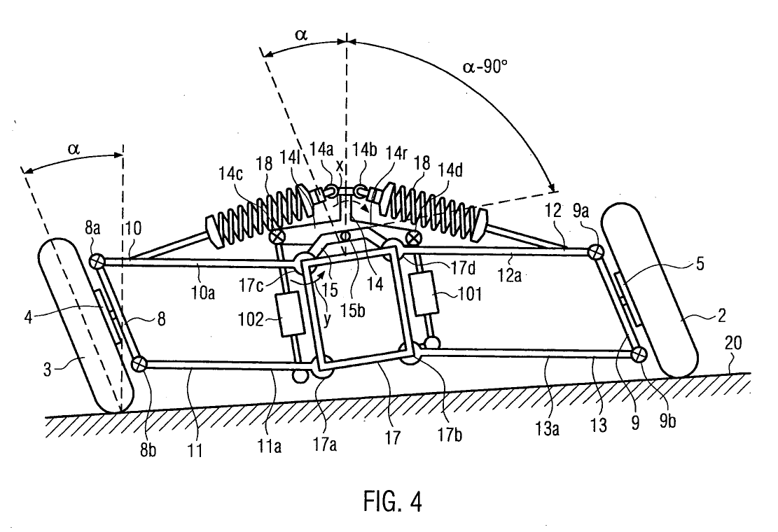

In the following, with reference to FIG. 4, a description will be given of the tilting behavior of the tilting module and system of FIGS. 1, 2 and 3. Again, in FIG. 4, those component parts already described with reference to previous figures are identified by the same reference numerals.

As soon as tilting of the vehicle implementing the tilting module and system depicted in FIG. 4 is required, for instance, during cornering of the vehicle, electrical current is supplied to the electric motor 108, illustrated in FIG. 6. Accordingly, the hydraulic pump 112 is driven, resulting in the hydraulic actuating means 102, 101 being also activated through the hydraulic pipes 104 and 103, respectively. That means that a rotational impulse is given to the rotatable tilting arm 14. Assuming that the rotating impulse is such as to rotate the rotatable tilting arm 14 in the direction of rotation x depicted in FIG. 4, so as to tilt it toward the right in FIG. 4, a corresponding displacement impulse is given to the suspension structure through the shock absorbers 18. However, in view of the resistance exerted by the suspension structure, neither the tilting arm or crank 14 is tilted to the right nor the suspension structure is displaced in the same direction. However, the resistance exerted by the suspension structure results in a reverse torque arising, with the reverse torque acting on the rigid frame 17, resulting in the rigid frame 17 being rotated in a direction contrary to the direction x, namely in the direction y depicted in FIG. 4. Accordingly, the rigid frame 17 is rotated an angle α in the direction of rotation y as a function of the vertical displacement of the actuating means 102 and 101. As stated above, the support arms 10, 11, 12 and 13 are each pivotally connected to the rigid frame 17 through the pivotable connection 17a, 17b, 17c, 17d, 17e, 17f, 17g and 17h, and as further illustrated in FIG. 1. Moreover, the uprights 9 and 8 are pivotally connected to the suspension arms 12, 13 and 10, 11, respectively, through the further pivotable connections 9a, 9b, and 8a, 8b. Finally, the shock absorbers 18 are pivotally connected to the suspension arms 8 and 12 through corresponding pivotable connections 18b and 18a.

Accordingly, the rotation of the rigid frame 17 of an angle α, as illustrated in FIG. 4 results in the whole suspension structure being tilted as depicted in FIG. 4 together with the wheels 3 and 2 which, as depicted in FIG. 4 are also tilted by the same angle α. Obviously, the same considerations as stated above also apply in the case of a rotating impulse in the direction contrary to the direction x being given to the rotatable tilting crank 14. In this case, the suspension structure would be tilted in a corresponding contrary or opposite direction.

It results, therefore, from the above that the tilting module and system according to the present invention is an active tilting module and system, namely a module and system wherein the tilting function is obtained through the action of hydraulic actuating means which may comprise one or more electric motors driving one or more hydraulic pumps. Alternatively, the tilting module may even be actuated manually.

It has, moreover, to be appreciated that rotating the rigid frame 17 by an angle α as depicted in FIG. 4 results in the whole vehicle being tilted by the same angle α, since the rigid frame 17 is adapted to be firmly fixed to the chassis or body of the vehicle. Accordingly, the resultant of gravity and the centrifugal forces acting on the vehicle is kept oriented along the vertical body axis of the vehicle, thus allowing it to avoid or at least minimize the rollover risk even if the track of the vehicle is narrow when compared to that of conventional vehicles.

For the purpose of exploiting the tilting function, the vehicle implementing the tilting module and/or system according to the present invention may be equipped with sensing means adapted to collect data relating to the dynamic behavior of the vehicle so as to activate the electric motor 108 and the pump 112, in the case of the embodiment depicted in FIG. 6, as a function of the data collected. In particular, as stated above, the sensing means may be comprised in the electronic control unit 111, depicted in FIG. 6, and may be of the kind adapted to collect data relating to the lateral acceleration and/or forces of the vehicle. Accordingly, as soon as the vehicle approaches a curve or in cornering were a driving action is exerted by the driver, the resulting lateral acceleration acting on the vehicle may be detected and measured and a corresponding signal may be sent to the power electronic unit 110 adapted to drive the electric motor 108, thus resulting in the vehicle being tilted so as to compensate for the lateral acceleration felt by the vehicle. This solution, in particular, allows for the compensation of any lateral acceleration, and also lateral acceleration arising in situation other than during cornering. For instance, in the case of lateral wind, also the resulting lateral acceleration acting on the vehicle can be detected and the vehicle can be tilted contrary to the lateral wind and also in the case of the vehicle traveling on a straight road.

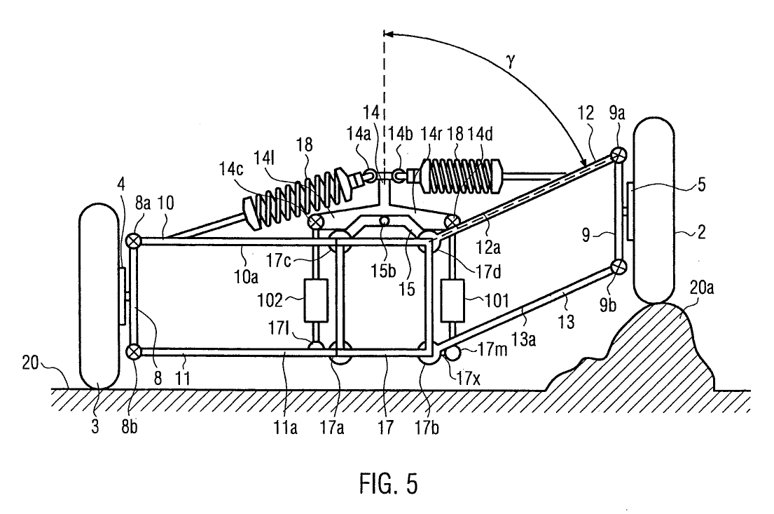

When one of the two wheels 2 and 3 crosses a bump, the tilting module and/or system according to the present invention behaves as depicted in FIG. 5, where like features depicted therein and already described with reference to previous figures are identified by like reference numerals.

In particular, in the embodiment of FIG. 5, it is assumed that the wheel 2 crosses a bump 20a of the surface of the road 20. In this case, as depicted in FIG. 5, the tilting module and/or system does not work because the vertical displacement of the wheel 2 is absorbed by the shock absorber 18. In particular, this is due to the action exerted by the hydraulic actuators 102 and 101 on the tilting crank 14, which, in turn, is connected to the shock absorber 18 through the pivotable connection 14b and 14a, illustrated in FIG. 2. Accordingly, the crank 14 is not tilted as a consequence of the perturbation or bump acting on the suspension structure, but only the wheel 2 is lifted as depicted in FIG. 5. The rigid frame 17 is therefore not rotated and the vehicle is not tilted.

Moreover, the way in which the vertical displacement of the wheel 2 is absorbed or compensated for by the shock absorber 18 may be summarized as follows. As depicted in FIG. 5, a vertical displacement of the wheel 2 results in the suspension structure or system being also vertically displaced. Accordingly, a force is exerted against the shock absorber 18 and a corresponding reaction or force is exerted by the shock absorber 18 on the suspension structure, and therefore on the wheel 2, contrary to the vertical displacement of the wheel, with the force varying in a linear manner as a function of the vertical displacement of the wheel 2. In other words, the resilient force exerted by the shock absorber 18 on both the suspension structure and the wheel 2 is proportional to the vertical displacement of the wheel 2. That means that high spring forces are exerted by the shock absorber 18 on the wheel 2 only in the case of large displacements of the wheel 2.

Although this behavior of the shock absorber 18 may be accepted in some circumstances, shock absorbing means with non-linear characteristics may be preferred in other circumstances such as, for example, in the case of light vehicles where the mass of the passengers and luggage is an important fraction of the overall mass of the vehicle. That is to say that shock absorbing means with a stiffness increasing with the load, i.e. with a stiffness increasing in a non-linear manner with the load may be preferred for the purpose of improving the comfort and the dynamics of the vehicle. In fact, shock absorbing means with a stiffness increasing with the load and/or the vertical displacement of the wheels may allow the keeping the natural frequency of the suspended mass to a fairly constant value. Moreover, shock absorbing means with a stiffness increasing non-linearly or more than proportionally as a function of the vertical displacement of the wheels may allow keeping the vertical displacement of the wheels lower than a predefined value, while this is not possible in the case of shock absorbing means where the stiffness is constant.

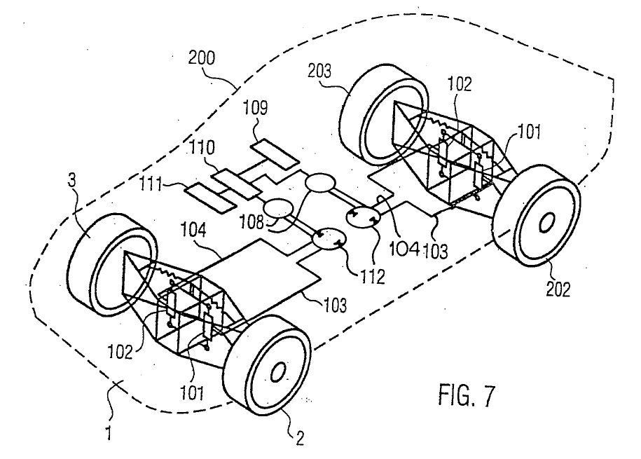

In the following, a first example of a vehicle implementing the suspension tilting module and system according to the present invention will be described with reference to FIG. 7, wherein, as usual, like features already described with reference to previous figures are identified by like reference numerals.

The vehicle 200 depicted in FIG. 7 is a four wheeled vehicle comprising two front wheels 2 and 3 disposed on a common front axle and two rear wheels 202 and 203 disposed on a common rear axle. Moreover, the vehicle 200 implements two suspension tilting modules according to the present invention, namely, a first tilting module supporting the front wheels 2 and 3 and a second tilting module supporting the rear wheels 202 and 203. Each of the tilting modules is equipped with hydraulic actuating means 102 and 101, the hydraulic actuating means 102 and 101 of each tilting module is hydraulically connected to one hydraulic pump 112 through corresponding hydraulic pipes 104 and 103. The two independent hydraulic pumps are driven by two independent electric motors 108 under the control of a power electronic unit 110 and an electronic control unit 111. Moreover, a battery 109 is provided, for supplying electrical power to the power electronic unit 110, the electronic control unit 111 and the electric motors 108. For example, the battery 109 may be the main battery of the vehicle 200, alternatively, the battery 109 may be an additional battery used in combination with the main battery of the vehicle 200.

The vehicle 200 may be of the kind comprising a main engine, not depicted in FIG. 7, for instance, a combustion engine. Alternatively, electric motors may be provided for the purpose of driving the wheels, for instance two electric motors may be received in the hubs of the front wheels 2 and 3. Alternatively, two electric motors may be received in the hubs of the rear wheels 202 and 203 or even four electric motors may be provided, received in the hubs of the four wheels 2, 3, 202 and 203.

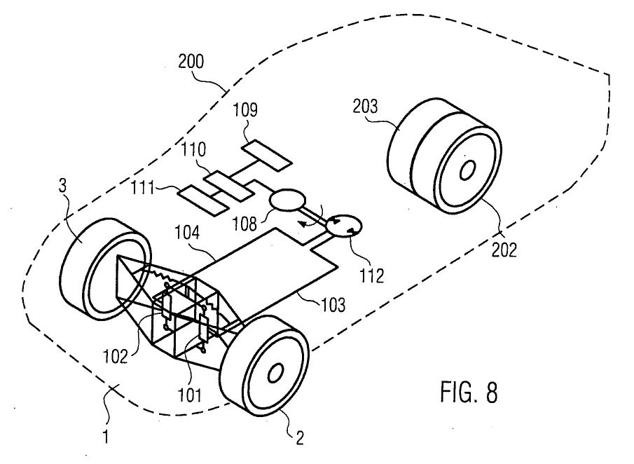

A further example of a vehicle implementing a suspension tilting module and system according to the present invention will be described with reference to FIG. 8, wherein, as usual, like features are identified by like reference numerals.

The main difference between the vehicle of FIG. 8 and that of FIG. 7 relates to the fact that the vehicle of FIG. 8 is a three wheeled vehicle. In particular, as depicted in FIG. 8, the two wheels 202 and 203 are placed adjacent to each other so as to form a single wheel. Alternatively, a single wheel may be used instead of the two adjacent wheels 202 and 203.

The same considerations as stated above with respect to the vehicle of FIG. 7 also apply to the vehicle of FIG. 8; in particular, additional hydraulic pumps 112, power electronic units 110, electronic control units 111 and batteries 109 may be implemented in the vehicle of FIG. 8, for instance for the purpose of obtaining power and electric control redundancy.

It has, therefore, been demonstrated that the suspension tilting module and system according to the present invention overcomes the problems or drawbacks affecting prior art suspension tilting modules. In particular, the advantages offered by the suspension tilting module and system according to the present invention with respect to prior art suspension tilting module and systems may be summarized as follows.

The suspension tilting module and system according to the present invention have a very simple electromechanical and/or electro hydraulic layout, and does not have transmission belts and no hydraulic control is needed.

A better optimization of the vehicle layout implementing the suspension tilting module and system according to the present invention is also possible due to the more compact layout with respect to purely mechanical or electro mechanical modules and systems.

There is no need of any mechanical link between the electric motor and the tilting mechanism, so that the electric motor and the hydraulic pump can be positioned at some distance from the hydraulic actuating means, thus allowing optimization of the overall assembly of the vehicle implementing them.

The overall mass of the tilting module and system according to the present invention is less than that of common electro mechanical tilting modules and systems.

In the module and system according to the present invention, less friction forces arise than in common suspension tilting modules and systems.

The control of the tilting torque can be directly controlled with the current in the electric motor without any need for control valves.

The tilting module according to the present invention can be easily and quickly transformed into a manually actuated tilting module.

In the tilting module and system according to the present invention, electromechanical layouts are possible offering high power and control redundancy, for instance implementing two hydraulic chains that work in parallel; accordingly, complete fully redundant systems may be provided.

The suspension tilting module according to the present invention is an active electro hydraulic tilting module working not only to brake the tilting movement, but also to actively carry out the tilting function.

The actuating tilting system according to the present invention can be regarded as a by-wire system as it only comprises electrical connections between the control signal coming from the driver or the electronic control unit and the electric motor.

Of course, it should be understood that a wide range of changes and modifications can be made to the embodiments described above without departing from the scope of the present invention. It has, therefore, to be understood that the scope of the present invention is not limited to the embodiments described, but is rather defined by the appended claims.

Further modifications and variations of the present invention will be apparent to those skilled in the art in view of this description. Accordingly, the description is to be construed as illustrative only and is for the purpose of teaching those skilled in the art the general manner of carrying out the present invention. It is to be understood that the forms of the invention shown and described herein are to be taken as the presently preferred embodiments.

What is claimed is:

1. A suspension tilting module for a wheeled vehicle comprising:
at least two wheels disposed on a common axle;
a suspension system adapted to support said at least two wheels allowing tilting of said at least two wheels;
a rigid frame adapted to be firmly fixed to a chassis of the wheeled vehicle;
a tilting arm pivotally supported by said rigid frame; and
a hydraulic actuator pivotally interposed between said rigid frame and said tilting arm, so that activation of said hydraulic actuator results in a force being exerted on said tilting arm and said rigid frame being tilted together with said at least two wheels.

2. A suspension tilting module as claimed in claim 1 wherein:
said tilting arm is pivotally connected to said rigid frame through a pivotable connection.

3. A suspension tilting module as claimed in claim 1 wherein:
said tilting arm comprises at least a first arm portion and in that said hydraulic actuator comprise at least a first hydraulic actuator adapted to exert a force on the at least first arm portion.

4. A suspension tilting module as claimed in claim 3 wherein:
said at least first hydraulic actuator comprises a first end portion and a second end portion, the first end portion being pivotally connected to the first arm portion through a pivotable connection, the second end portion being pivotally connected to the rigid frame through a pivotable connection.

5. A suspension tilting module as claimed in claim 4 wherein:
said at least first hydraulic actuator comprises a hydraulic cylinder.

6. A suspension tilting module as claimed in claim 5 wherein:
said hydraulic cylinder is a single effect hydraulic cylinder.

7. A suspension tilting module as claimed in claim 3 wherein:
said tilting arm comprises a second arm portion and in that said hydraulic actuator comprise a second hydraulic actuator adapted to exert a force on the second arm portion.

8. A suspension tilting module as claimed in claim 7 wherein:
the second hydraulic actuator comprises a first end portion and a second end portion, the first end portion being pivotally connected to the second arm portion through a pivotable connection, the second end portion being pivotally connected to the rigid frame through a pivotable connection.

9. A suspension tilting module as claimed in claim 8 wherein:
the second hydraulic actuator comprises a hydraulic cylinder.

10. A suspension tilting module as claimed in claim 9 wherein:
the hydraulic cylinder is a single effect hydraulic cylinder.

11. A suspension tilting module as claimed in claim 1 further comprising:
at least one hydraulic pump hydraulically connected to said hydraulic actuator.

12. A suspension tilting module as claimed in claim 11 wherein:
said at least one hydraulic pump is a fixed displacement hydraulic pump.

13. A suspension tilting module as claimed in claim 11 further comprising:
at least one electric motor adapted to drive said at least one hydraulic pump.

14. A suspension tilting module as claimed in claim 11 further comprising:
at least one isolation valve hydraulically interposed between said hydraulic actuator and said at least one hydraulic pump and adapted to close the intakes of said hydraulic actuator so as to hydraulically isolate said hydraulic actuator from said at least one hydraulic pump.

15. A suspension tilting module as claimed in claim 1 wherein:
said tilting arm is pivotally connected to said suspension system through shock absorbers.

16. A suspension tilting module as claimed in claim 15 wherein:
said tilting arm is pivotally connected to a first shock absorber and a second shock absorber through pivotable connections, respectively.

17. A suspension tilting module as claimed in claim 1 wherein:
said rigid frame is pivotally connected to suspension arms of said suspension system, with the suspension arms supporting said at least two wheels so that activation of said hydraulic actuator results in said rigid frame being tilted together with said at least two wheels.

18. A suspension tilting module as claimed in claim 17 wherein:
the suspension arms comprise a first upper arm and a first lower arm adapted to pivotally support, in combination, a first wheel of said at least two wheels, as well as a second upper arm and a second lower arm adapted to pivotally support, in combination, a second wheel of said at least two wheels so as to allow tilting of the first and second wheels.

19. A module as claimed in claim 18 wherein:
said suspension system comprises a first upright pivotally connected to both the first upper arm and the first lower arm and adapted to support a first wheel of said at least two wheels, as well as a second upright pivotally connected to both the second upper arm and the second lower arm and adapted to support a second wheel of said at least two wheels, the first and second uprights allowing steering of the first and second wheels on corresponding steering axes substantially vertical and being adapted to be tilted together with the first and second wheels, respectively.

20. A suspension tilting module as claimed in claim 19 wherein:
the first upright comprises a first upper pivotable connection pivotally connecting the first upright to the first upper arm and a first lower pivotable connection pivotally connecting the first upright to the first lower arm and in that the second upright comprises a second upper pivotable connection pivotally connecting the second upright to the second upper arm and a second lower pivotable connection pivotally connecting the second upright to the second lower arm, the first upper and lower pivotable connections allowing both tilting and steering of the first upright, the second upper and lower pivotable connections allowing both tilting and steering of the second upright.

21. A driving tilting suspension system for a wheeled vehicle comprising:
at least two wheels disposed on a common axle;
a suspension system adapted to support said at least two wheels allowing tilting of said at least two wheels;
a rigid frame adapted to be firmly fixed to a chassis of the wheeled vehicle;
a tilting arm pivotally supported by said rigid frame;
a hydraulic actuator pivotally interposed between said rigid frame and said tilting arm, so that activation of said hydraulic actuator results in a force being exerted on said tilting arm and said rigid frame being tilted together with said at least two wheels; and
control means, coupled to said hydraulic actuator, for controlling said hydraulic actuator,
whereby cornering of the wheeled vehicle is improved.

22. A driving tilting suspension system as claimed in claim 21 further comprising:
an electronic control unit adapted to collect data relating to the driving condition and/or the behavior of the wheeled vehicle and to emit electrical signals as a result of the collected data.

23. A driving tilting suspension system as claimed in claim 22 further comprising:
means adapted to collect the electrical signals and to drive said hydraulic actuator as a function of the electrical signals as collected.

24. A driving tilting suspension system as claimed in claim 23 wherein:
said means adapted to collect the electrical signals comprise at least one electronic control unit electrically connected to a power electronic unit and to said hydraulic actuator.

25. A driving tilting suspension system as claimed in claim 24 wherein:
the electronic control unit is electrically connected to at least one electric motor so as to drive the at least one electric motor as a function of the electrical signals as collected.

26. A wheeled vehicle comprising:
at least two wheels disposed on a common axle;
a suspension system adapted to support said at least two wheels allowing tilting of said at least two wheels;
a rigid frame adapted to be firmly fixed to a chassis of the wheeled vehicle;
a tilting arm pivotally supported by said rigid frame;
a hydraulic actuator pivotally interposed between said rigid frame and said tilting arm, so that activation of said hydraulic actuator results in a force being exerted on said tilting arm and said rigid frame being tilted together with said at least two wheels; and
control means, coupled to said hydraulic actuator, for controlling said hydraulic actuator,
whereby cornering of the wheeled vehicle is improved.

27. A wheeled vehicle as claimed in claim 26 wherein:
the wheeled vehicle is a three wheel vehicle wherein the at least two wheels are front wheels and further comprising one rear wheel.

28. A wheeled vehicle as claimed in claim 26 further comprising:
a second set of at least two wheels disposed on a common axle;
a second suspension system adapted to support said second set of at least two wheels allowing tilting of said second set of at least two wheels;
a second rigid frame adapted to be firmly fixed to a chassis of the wheeled vehicle;
a second tilting arm pivotally supported by said second rigid frame; and
a second hydraulic actuator pivotally interposed between said second rigid frame and said second tilting arm and coupled to said control means, so that activation of said second hydraulic actuator results in a force being exerted on said second tilting arm and said second rigid frame being tilted together with said second set of at least two wheels.

29. A wheeled vehicle as claimed in claim 26 wherein:
the wheeled vehicle is a four wheeled vehicle comprising two front wheels and two rear wheels, either the two front wheels or the two rear wheels being driven by a main engine, and in that the two wheels not driven by the main engine are rotatably supported by said suspension system.

30. A wheeled vehicle as claimed in claim 26 further comprising:
a fluid reservoir containing a hydraulic fluid, the fluid reservoir being hydraulically connected to said hydraulic actuator.

31. A wheeled vehicle as claimed in claims 26 further comprising:
an electrical power storage means electrically connected to said hydraulic actuator.

32. A wheeled vehicle as claimed in claim 31 wherein:
said electrical power storage means comprises a main battery of the wheeled vehicle.
